(19) United States
(12) Patent Application Publication
(10) Pub. No.: US 2024/0028917 A1
(43) Pub. Date: Jan. 25, 2024

(54) GENERATING A KNOWLEDGE BASE FROM MATHEMATICAL FORMULAE IN TECHNICAL DOCUMENTS

(71) Applicants: Siemens Aktiengesellschaft, München (DE); Indian Institute of Science, Bengaluru, Karnataka (IN)

(72) Inventors: Aritra Chatterjee, Kolkata, West Bengal (IN); Partha Talukdar, Bangalore, Karnataka (IN); Fakabbir Amin, Bangalore, Karnataka (IN); Srinidhi Kulkarni, Bangalore, Karnataka (IN)

(21) Appl. No.: 18/023,623

(22) PCT Filed: Aug. 31, 2021
(86) PCT No.: PCT/IN2021/050839

§ 371 Date: Feb. 27, 2023

(30) Foreign Application Priority Data
Aug. 31, 2020 (IN) 202031037442

(51) Int. Cl. G06N 5/022; G06N 7/00

(52) U.S. Cl. CPC G06N 5/022; G06N 7/00

(57) ABSTRACT

A system and method for extracting mathematical formulae from the one or more technical documents is disclosed. The method includes identifying variables and a concept associated with each of the variables from the one or more technical documents. The method includes determining interdependencies between variables in the extracted mathematical formulae based on the identified variables and the concept associated with the variables. The method includes generating the knowledge base based on the determined interdependencies. The method further includes providing access to the knowledge base to an end-user.

### CROSS-REFERENCE TO RELATED APPLICATIONS

This application claims priority to PCT Application No. PCT/IN2021/050839, having a filing date of Aug. 31, 2021, which claims priority to IN Application No. 202031037442, having a filing date of Aug. 31, 2020, the entire contents both of which are hereby incorporated by reference.

### FIELD OF TECHNOLOGY

The following relates to knowledge extraction, and more particularly relates to a system and a method for generating a knowledge base from mathematical formulae in technical documents.

### BACKGROUND

Often, core engineering, scientific experimental culminations and physical concepts are modeled by mathematical formulae, which describe the relationship between different physical, epistemological or conceptual variables. These physical variables may be associated with physical measurements or concepts. Currently, there are no effective methods to retrieve relevant formulae for an engineering application at hand by machines from pre-existing technical documents.

For example, if an engineer is interested in understanding more about mathematical formulae associated with a particular concept or task, there are no methods to obtain such information from a corpus of documents. Query-based searches are limited to search by keywords or semantic search, while wholly excluding mathematical formulae. Similarly, for a novice in a technical domain, currently there is no method for easily getting an overview of mathematical formulae and inter-relationship amongst various variables pertaining to the technical domain.

In existing art, retrieval of mathematical formulae from technical documents has entirely been done manually. In some cases, a lookup table or a dictionary may be created which is then queried based on keywords. For example, the look up table may pertain to mathematical formulae needed for different engineering tasks. An end user can search for a keyword, which is found in the lookup table and the correspondingly mapped formulae could be displayed. Further, certain available softwares may also convert images of mathematical formulae to text. However, such softwares are unable to identify concepts pertaining to the mathematical formulae based on context within which the mathematical formulae appear. Such softwares fail to link the formulae with any other key information around the formulae that is present in typical engineering document, thus losing the essence and meaning of the formulae being captured.

In some of the notable conventional arts, the creation of base with several comparable insights or ways of mathematical symbol recognition or works only on snipped images is disclosed. The attempt to elucidate the limitations in extraction of mathematical formulae from technical document may be a PDF, Graphics (JPEG or PNG) or xhtml document, is made in embodiments of the current invention.

In light of the above, there exists a need for generating a knowledge base of mathematical formulae that are extracted from and presented in technical documents.

Therefore, embodiments of the present invention provides an efficient searchable database for mathematical formulae in technical documents, that search and extract the formulae based on the concepts the formulas are linked to.

### SUMMARY

An aspect relates to a system and method for generating a knowledge base from mathematical formulae in technical documents.

An aspect relates to obtain a machine comprehensible ontological structure specifically using mathematical formula is solved by building a knowledge graph that has relations between mathematical concept or equation feature s and the variables that mention them in one or more technical documents.

For example, an aspect relates to a system and a related method for building a searchable graph-based relational data model for representing a knowledge database of mathematical formulae present in technical documents.

Embodiments of the current invention depicts a method and a system for extraction of mathematical inlets (formulae and symbols) from a technical document which may be a PDF, Graphics (JPEG or PNG or standard galactic scripts) or xhtml document. Embodiments of the invention also may appraise a cluster of formulae for a subject matter with an overall understanding of the related concepts or equation features expressed in a technical document.

Embodiments of the present invention provide effective methods to retrieve relevant formulae for an engineering application at hand by machines. Machine comprehensible ontological structure specifically using mathematical formula is solved by building a knowledge graph that has relations between physical or mathematical concepts or equation features associated and the variables that mention them when searched through technical documents. The steps include extracting mathematical terms from the documents, performing ‘Variable Typing’, performing ‘Variable Linking’, creating a knowledge graph with interrelations of formulas and concept or equation features and finally retrieving the formulas associated with a question. Also, it includes feature to implement neural network to perform functions smoothly.

An aspect relates to a method for building a knowledge database for mathematical formulae present in one or more technical documents and to analyze the text from the whole document and relate a symbol or expression to identify and extract such formulae from. In an embodiment of the present invention, the method comprises execution of a system to include a knowledge management module configured for extracting one or more mathematical formulae from the one or more technical documents; identifying a mathematical concept and one or more variables associated with the mathematical concept from the extracted mathematical formulae; determining interdependencies between the identified one or more variables in the extracted mathematical formulae for linking the identified one or more variables, based on the identified one or more variables and the mathematical concepts associated with the one or more variables; and creating one or more entities that are interconnected to each other in a graph-based data model, wherein the one or more entities include at least one or more of:
a concept entity to capture information related to the identified mathematical concept,
a variable entity to capture information related to each of the identified one or more variables associated with the mathematical concept,
a formula entity to capture information related to each of the extracted mathematical formulae, and
a first relationship entity to capture information related to interconnection between the identified mathematical concept and the identified one or more variables associated with that mathematical concept, and
a second relationship entity to identify interconnection between the formula entity with one or more variable entities with respect to certain mathematical formula.

By creating the graph-based data model including the one or more entities representing the mathematical formulae, the knowledge management module included in the system, converts the mathematical formulae into searchable objects and stores the searchable mathematical formulae into the knowledge database included in the apparatus.

In an embodiment of the present invention, for extracting the one or more mathematical formulae from the one or more technical documents the knowledge management module included in the apparatus identifies one or more formulae regions in the one or more technical documents and converts the formulae regions into machine readable format.

In an embodiment of the present invention, the formulae regions are regions in the one or more technical documents that contain the mathematical formulae, and the formulae region includes at least one of an ‘Inline formula’ or a ‘Block Formulae’, and the Inline formulae refer to the mathematical formulae or the one or more variables that are part of natural language text lines in the one or more technical documents, and the Block formulae refer to the mathematical formulae that are separately written in blocks including between paragraphs of text.

In an embodiment of the present invention, the machine learning model trains the neural network on a set of annotated images of the technical documents to identify both block formulae and inline formulae.

In an embodiment of the present invention, the neural network is a Masked Region—Convolutional Neural Network that is trained on a set of annotated images of the technical documents to identify both the block formulae and the inline formulae and convert both the block formulae and the inline formulae into machine-readable format using a trained Masked Region—Convolutional Neural Network model.

In an embodiment of the present invention, for identifying of a mathematical concept and one or more variables associated with the mathematical concept, the knowledge management module included in the apparatus converts the machine readable format of the formulae regions into a mathematical vector representation using flags, where each word in the formulae regions is represented in the mathematical vector representation by an aggregation of three components including a type flag for flagging a mathematical concept to each word in the formulae regions; a variable flag for flagging a variable to each word in the formulae regions; and a word embedding of constituent words in the formulae regions,

In an embodiment of the present invention, a classification model is further implemented by the knowledge management module to classify an edge between two words in the mathematical concept indicating the edge relates the two words together or not.

In an embodiment of the present invention, the classification model is a Convolutional Neural Network (CNN) classifier.

In an embodiment of the present invention, for determining the interdependencies between the identified one or more variables in the extracted mathematical formulae, the knowledge management module identifies all of the variables occurring inside each of the formulae regions which is in the machine readable format; uses the identified mathematical concepts to identify relations between the variables; inputs the identified variables and the mathematical concepts to a string-matching module that links the identified variables with the identified mathematical concepts and in turn with the extracted mathematical formulae.

In an embodiment, the system includes a Graphical User Interface for visual representation of the graph-based data model.

In an embodiment, the system further includes a communication unit for communicating with a client device via a network for providing access of the knowledge database to the client device for the client device to search through the knowledge database and to obtain one or more mathematical formulae, related to a mathematical concept, stored in the knowledge database.

In an embodiment, the system receives the technical documents at least from at least one of the client device, a web source, a node residing on the network, or another apparatus in the network.

In clear words, the prominent feature of embodiments of the current invention is that it can access and or extracts the information from both searchable and non-searchable technical documents and manages them by a building a knowledge base. The knowledge base in embodiments of the present invention is built with relations obtained after linking the variable and equations are translated into a graph containing edges and nodes. The graph can be stored on Graph Databases such as D-Graph, this allows the knowledge graph to be searched using graph queries.

In an embodiment the present invention provides a system and method to obtain a machine comprehensible ontological structure specifically using mathematical formula is solved by building a knowledge graph that has relations between mathematical concept or and the variables that mention them in one or more technical documents

### BRIEF DESCRIPTION

Some of the embodiments will be described in detail, with reference to the following figures, wherein like designations denote like members, wherein:

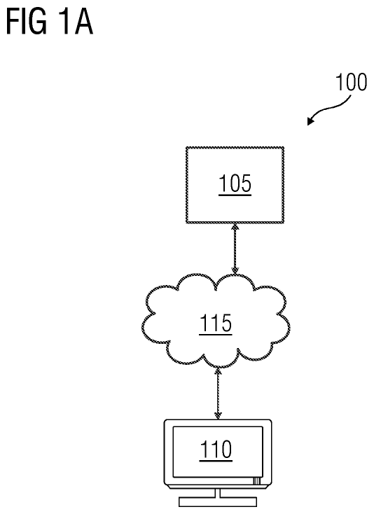

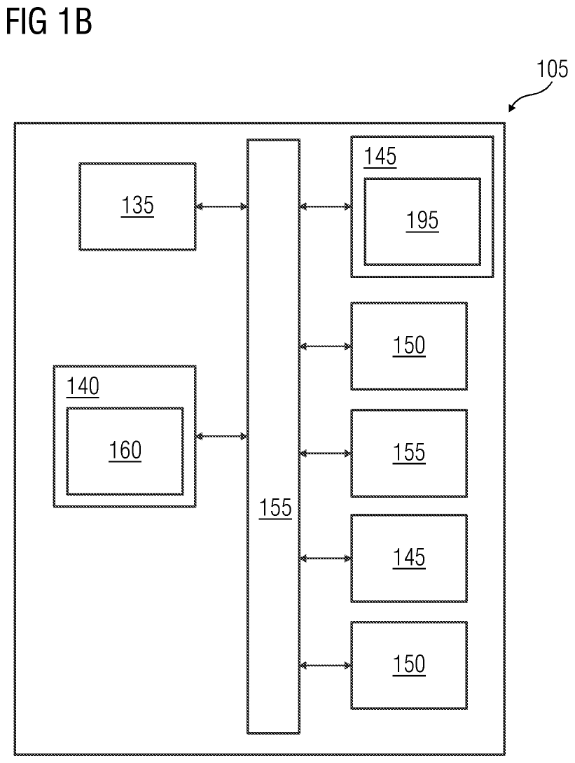

FIG. 1A illustrates a block diagram of a system for generating a knowledge base from mathematical formulae in technical documents, in accordance with an embodiment of the present invention;

FIG. 1B illustrates a block diagram of an apparatus for generating a knowledge base from mathematical formulae in technical documents, in accordance with an embodiment of the present invention;

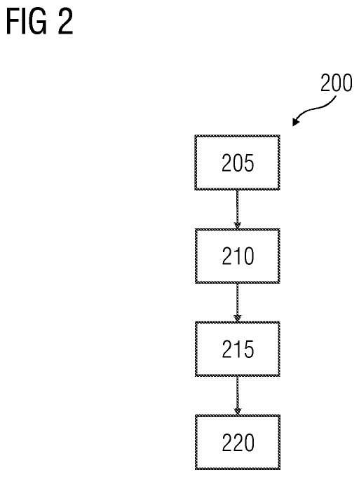

FIG. 2 depicts a flowchart of a method for generating a knowledge base from mathematical formulae in one or more technical documents, in accordance with an embodiment of the present invention;

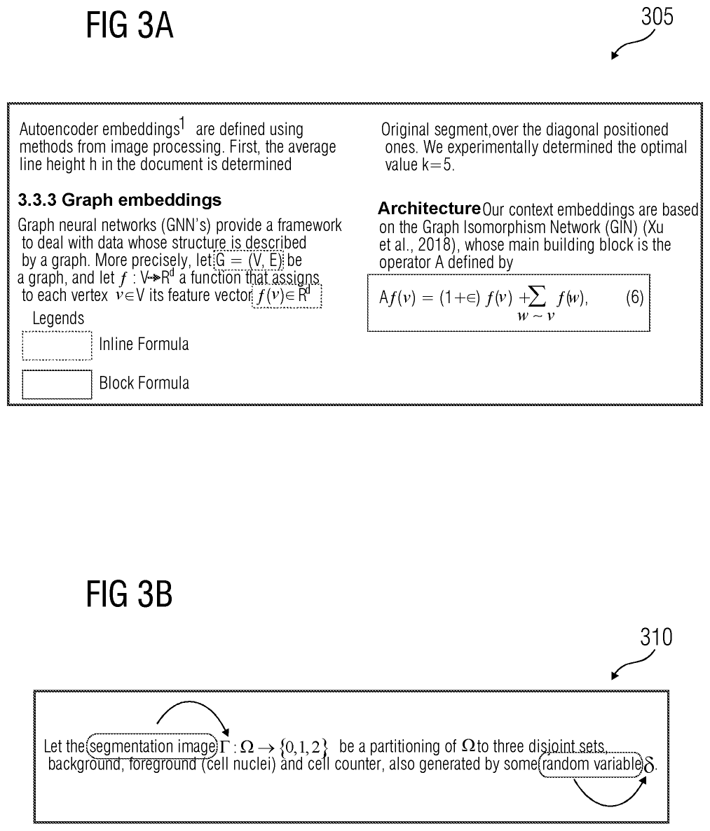

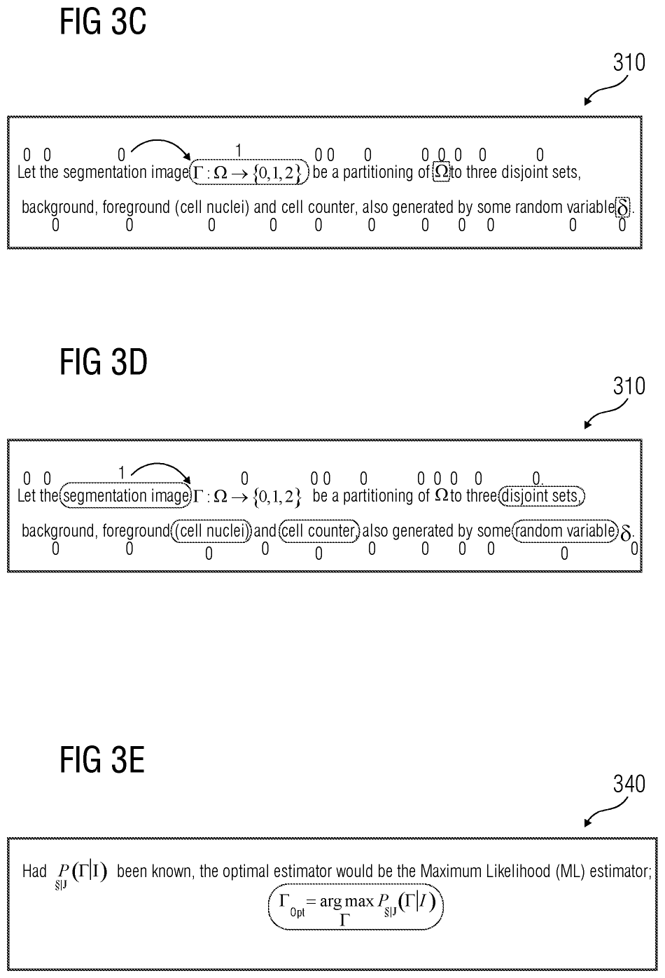

FIG. 3A illustrates identification of inline formulae and block formulae in a sample snippet of a technical document, as displayed on a Graphical User Interface, in accordance with an embodiment of the present invention;

FIG. 3B shows an example of a mathematical block, as displayed on a Graphical User Interface, extracted from the one or more technical documents, in accordance with an embodiment of the present invention;

FIG. 3C shows assignment of variable flags to the block, as displayed on a Graphical User Interface, in accordance with an embodiment of the present invention;

FIG. 3D shows assignment of type flags to the block, as displayed on a Graphical User Interface, in accordance with an embodiment of the present invention;

FIG. 3E shows an example of a relation identified between a variable and a block formula, as displayed on a Graphical User Interface, in accordance with an embodiment of the present invention;

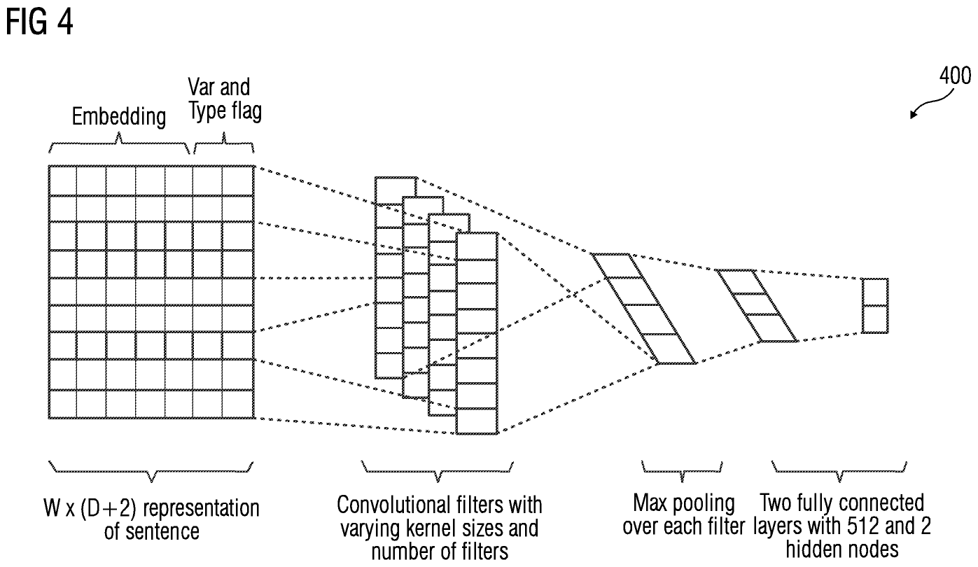

FIG. 4 illustrates structure of a CNN classifier, as displayed on a Graphical User Interface, in accordance with an embodiment of the present invention classifies the variables as per the related mathematical concept; and

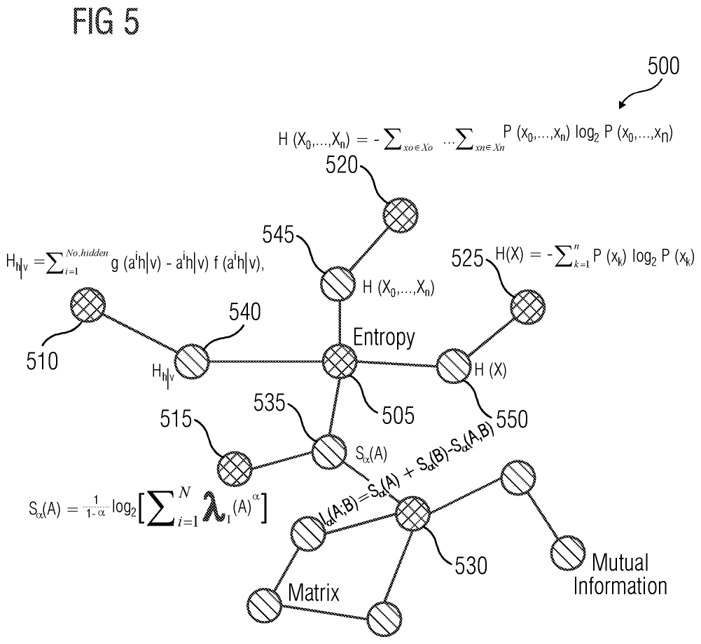

FIG. 5 is a Graphical User Interface view of a knowledge base, in accordance with an embodiment of the present invention.

### DETAILED DESCRIPTION

Hereinafter, embodiments for carrying out embodiments of the present invention are described in detail. The various embodiments are described with reference to the drawings, wherein like reference numerals are used to refer to like elements throughout. In the following description, for purpose of explanation, numerous specific details are set forth in order to provide a thorough understanding of one or more embodiments. It may be evident that such embodiments may be practiced without these specific details.

The Abbreviations used in the text are as per common parlance and as used in the art.

The problem of obtaining a machine comprehensible ontological structure specifically using mathematical formula is solved by building a knowledge graph that has relations between mathematical concepts and the variables that mention them when searched through technical documents.

Embodiments of the present invention started with a technical document from different domains such as Physics, Mathematics, Computer Science, Quantitative Biology, Quantitative Finance and Statistics. These documents are typically in the forms of PDFs or xhtml or LaTeX documents. The process of obtaining the knowledge graph of mathematical concept or equation feature s from these documents is described herein in the following paragraphs:

A method (200) for building a knowledge database for mathematical formulae present in one or more technical documents, comprising the steps for extracting, by a knowledge management module (160) executable by one or more processing units (120), one or more mathematical formulae from the one or more technical documents; identifying, by a knowledge management module (160), a mathematical concept and one or more variables associated with the mathematical concept from the extracted mathematical formulae; and determining, by a knowledge management module (160), interdependencies between the identified one or more variables in the extracted mathematical formulae for linking the identified one or more variables, based on the identified one or more variables and the mathematical concepts associated with the one or more variables; and generating a knowledge graph based on the linkings of variable and mathematical concept associated. The method, wherein the knowledge management module (160) executable by one or more processing units (120) perform the function of extracting the mathematical formulae, identifying variables associated with the mathematical and determining interdependencies between the identified one or more variables so as to create one or more entities that are interconnected to each other in a graph-based data model, wherein the one or more entities include at least one or more of a concept entity (505) to capture information related to the identified mathematical concept; a variable entity (535, 540, 545 and 550) to capture information related to each of the identified one or more variables associated with the mathematical concept; a formula entity (505, 510, 515, 520, 525 and 530) to capture information related to each of the extracted mathematical formulae; a first relationship entity to capture information related to interconnection between the identified mathematical concept and the identified one or more variables associated with the mathematical concept, and a second relationship entity to identify interconnection between the formula entity with one or more variable entities with respect to certain mathematical formula and wherein, by creating the graph-based data model including the one or more entities representing the mathematical formulae, the knowledge management module (160) converts the mathematical formulae into searchable objects and stores the searchable mathematical formulae in the knowledge base included in the system. As per the method, for extracting the one or more mathematical formulae from the one or more technical documents, the knowledge management module (160) is executable by the one or more processing units (120) to implement a machine learning model that uses a neural network to identify one or more formulae regions in the one or more technical documents, wherein the formulae regions are regions in the one or more technical documents that contain the mathematical formulae, and wherein the formulae region includes at least one of an ‘Inline formula’ or a ‘Block Formulae’, and wherein the Inline formulae refer to the mathematical formulae or the one or more variables that are part of natural language text lines in the one or more technical documents, and the Block formulae refer to the mathematical formulae that are separately written in blocks including between paragraphs of text; to convert the formulae regions into machine readable format, and the machine learning model trains the neural network on a set of annotated images of the technical documents to identify both block formulae and inline formulae.

The method wherein for the identifying of the mathematical concept and one or more variables associated with the mathematical concept, the knowledge management module (160) is executable by the one or more processing units (120) in the method (200) to convert the machine-readable format of the formulae regions into a mathematical vector representation using flags, wherein each word in the formulae regions is represented in the mathematical vector representation by an aggregation of three components including a type flag for flagging a mathematical concept to each word in the formulae regions; a variable flag for flagging a variable to each word in the formulae regions; and a word embedding of constituent words in the formulae regions, and wherein a classification model is further implemented by the knowledge management module (160) to classify an edge between words in the mathematical concept indicating the edge relates the two words together or not is disclosed hereby.

In the method (200) depicted for determining the interdependencies between the identified one or more variables in the extracted mathematical formulae, the knowledge management module (160) is executable by the one or more processing units (120) in the method (200) to identify all of the variables occurring inside each of the formulae regions which is in the machine readable format; use the identified mathematical concepts to identify relations between the variables; input the identified variables and the mathematical concepts to a string-matching module that links the identified variables with the identified mathematical concepts and in turn with the extracted mathematical formulae.

The method, wherein executing one or more processing units (120) in the method (200) using the knowledge management module (160) to communicate with a client device (110) communicating via a network (115) for the client device (110) to search through the knowledge database and to obtain one or more mathematical formulae, related to a mathematical concept, stored in the knowledge database; to provide the graph-based data model to the client device (110) for obtaining one or more mathematical formulae related to a mathematical concept, stored in the knowledge database; to visually represent the graph-based data model at a Graphical User Interface of a system (105) or the client device (110); and wherein the knowledge management module (160) receives the technical documents at least from at least one of the client device ((110)) communicating with the knowledge management module (160) via the network (115), a web source, a node residing on the network (115), or an system (105) in the network (115), individually or in any combination.

The method, wherein for the identifying of a mathematical concept and one or more variables associated with the mathematical concept, the knowledge management module (160) is configured to perform conversion of the machine-readable format of the inline formulae regions into a mathematical vector representation using flags, wherein each word in the formulae regions is represented in the mathematical vector representation by an aggregation of three components including a type flag for flagging a mathematical concept to each word in the formulae regions; a variable flag for flagging a variable to each word in the formulae regions; and wherein a word embedding of constituent words in the formulae regions, and a classification model is implemented by the knowledge management module (160) to classify an edge between two words with variable tags to identify the variables related to the mathematical concept is disclosed.

The method, wherein to identify the mathematical concept, present in the formulae regions, an extensive list of keywords as potential concept is used by the knowledge management module (160), and wherein the classification model is a CNN classifier (400) is depicted.

As per the method described, the knowledge management module (160) is further configured to apply one or more heuristics approaches to improve accuracy, where the one or more heuristics approaches at least includes at least Superscript, subscript invariant string matching, where variables i.e. x, xi, xj are considered variables of the same type; or consider only the L.H.S. of the mathematical formulae as variables.

Embodiments of the present invention depict a system (105) for building a knowledge base for mathematical formulae present in one or more technical documents, which includes one or more processing units (120); a memory (125) coupled to the one or more processing unit (120) for execution of one or more machine-readable instructions; and a knowledge management module (160) stored in the memory (125), and wherein, upon execution of the one or more machine-readable instructions, by the processing unit (120), causes the knowledge management module (160) to perform the method (200) described.

FIG. 1A illustrates an exemplary block diagram representing a system 100 for generating a knowledge base from mathematical formulae in one or more technical documents, in accordance with an embodiment of the present invention. The FIG. 1A shows the system 105 that may be implemented for building a graph-based searchable relational data model or structure for generating a knowledge database of one or more mathematical formulae that may be extracted from one or more technical documents. The graph-based relational data model or structure may include one or more relationships between the mathematical or scientific concept or culmination or equation features and the one or more variables that define these concept or culmination or equation features in the technical documents. The one or more variables can define or relate to these concepts or equation features in a way such that the relationships between them, as included in the graph-based data model, may provide a contextual and scientific meaning for a particular representation of a formula in the database. Thus, any variable, directly or indirectly related to a mathematical or scientific concept or culmination, may be used in building the graph-based relational data model for generating the knowledge database of the mathematical or scientific formulas. By building such graph-based relational data model, a knowledge database of one or more mathematical formulae may be created that may be searchable for formulas and may extract formulas based on mathematical or scientific concepts or equation features rather than only keywords or variables.

Non-limiting examples of technical documents include publications, articles, textbooks, report and documentation. The technical document is in one of a searchable format and a non-searchable format. Specifically, searchable formats allow a user to search through the document for specific text with the help of keywords. Non-limiting examples of searchable formats include knowledge models, searchable PDFs, emails, Word, Excel, XML, XHTML and HTML. On the contrary, non-searchable formats include non-searchable Portable Document Formats (PDFs), Portable Network Graphics (PNG) format, Joint Photographic Experts Group (JPEG) format etc. Non-limiting examples of knowledge bases include graph database, a relational database, an object database, a hierarchical database, and a structured storage database.

The method depicted, colludes with the system (105) which comprises a processing unit (120), a memory (125), a storage unit (130), a communication unit (135), a network interface (140), an input unit (145), an output unit (150), a standard interface or bus (155); a knowledge management module (160) which is configured for extracting mathematical formulae from the one or more technical documents; and one or more client devices (110). Non-limiting examples of client devices (110) include personal computers, mobile phones, smart phones, tablets, I-Pads, personal digital assistants, cameras, scanners, and workstations. The client devices (110) may be any device that may be used to receive one or more documents from a user, which may be any computing device, and may directly or indirectly upload these documents to another device or apparatus or the said system (105). In the present embodiment, the system (105) is a server. The one or more client devices (110) is connected to the system (105) via a network (115). Non-limiting examples of the network (115) include any wired or wireless networks, or in any combination, such as local area network (LAN), wide area network (WAN), WiFi, etc.

The client device (110) includes a device configured to receive one or more technical documents from a user. In an example, the technical documents may be stored on the client device (110) in soft copy formats. In another example, the user may upload the technical document to the client device (110) through peripheral devices such as scanners, cameras, hard disks, CD-ROMs and so on. In case of documents existing in hard copy format, the technical document may be a scanned image of the document. In addition to the technical document, the user may also provide inputs such as annotations that are specific to the technical document. The one or more client devices (110) may also be configured to convert the technical document to a format suitable for processing at the system (105).

The one or more client devices (110) may also include a user device, used by the user. In an embodiment, the user device may be used by the user, to send requests or data to the server for generating a knowledge base from mathematical formulae in one or more technical documents. The knowledge base may be further accessed or queried by the user via a Graphical User Interface or an application programming interface provided by an application associated with the client device (110). The application may be one of a web-based application and a client-based application. In another embodiment, a request may be sent to the system (105) to access the knowledge base via the network (115).

The said system (105) comprises at least one or more of a processing unit (120), a memory (125), a storage unit (130), a communication unit (135), a network interface (140), an input unit (145), an output unit (150), a standard interface or bus (155), as shown in FIG. 1B. The system (105) can be a (personal) computer, a workstation, a virtual machine running on host hardware, a microcontroller, or an integrated circuit. As an alternative, the system (105) can be a real or a virtual group of computers (the technical term for a real group of computers is “cluster”, the technical term for a virtual group of computers is “cloud”). The term ‘processing unit’, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit.

The processing unit (120) may also include embedded controllers, such as generic or programmable logic devices or arrays, application specific integrated circuits, single-chip computers, and the like. In general, the processing unit (120) may comprise hardware elements and software elements. The processing unit (120) can be configured for multithreading, i.e. the processing unit (120) may host different calculation processes at the same time, executing the either in parallel or switching between active and passive calculation processes. The memory (125) may include one or more of a volatile memory and a non-volatile memory. The memory (125) may be coupled for communication with the processing unit (120).

The processing unit (120) may execute instructions and or code stored in the memory (125). A variety of computer-readable storage media may be stored in and accessed from the memory (125). The memory (125) may include any suitable elements for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, and the like. The memory (125) comprises a knowledge management module 160 that may be stored in the memory (125) in the form of machine-readable instructions and executable by the processing unit (120). These machine-readable instructions when executed by the processing unit (120) causes the processing unit (120) to perform functions associated with generating a knowledge base from mathematical formulae in one or more technical documents.

The knowledge management module (160) is configured for extracting formulae from one or more technical documents. The formulae can be any of mathematical or scientific formulae. Hereinafter, the terms mathematical formulae or scientific formula or formulae may be interexchangeably used without deviating from the meaning and scope of embodiments of the present invention. The knowledge management module (160) is further configured to identify variables and a concept associated with each of the variables from the one or more technical documents. The knowledge management module (160) is further configured to determine interdependencies between variables in the extracted mathematical formulae based on the identified variables and the concepts associated with the variables. The knowledge management module (160) is further configured to generate the knowledge base based on the determined interdependencies. In addition to the above, the knowledge management module (160) is further configured to provide access to the knowledge base to an end-user. The function of the knowledge management module 160 is described in detail using the method 200, later in the description.

The storage unit (130) comprises a non-volatile memory which stores the database (195). The database (195) may store, for example, a knowledge base of mathematical formulae extracted from various technical documents, corpus and so on. The input unit (145) may include input means such as keypad, touch-sensitive display, camera, etc. capable of receiving inputs.

The output unit (150) may include output means such as monitors, Human Machine Interfaces etc. The bus (155) acts as interconnect between the processing unit (120), the memory (125), the storage unit (130), and the network interface (140). The communication unit (135) enables the apparatus (105) to communicate with the one or more client devices (110). The communication unit (135) may support different standard communication protocols such as Transport Control Protocol or Internet Protocol (TCP or IP), Profinet, Profibus, Bluetooth and Internet Protocol Version (IPv). The network interface 140 enables the system (105) to communicate with the one or more client devices (110) over the network (115).

The system (105) in accordance with an embodiment of the present invention includes an operating system employing a graphical user interface. The operating system permits multiple display windows to be presented in the graphical user interface simultaneously with each display window providing an interface to a different application or to a different instance of the same application. A cursor in the graphical user interface may be manipulated by a user through the pointing device. The position of the cursor may be changed and or an event such as clicking a mouse button, generated to actuate a desired response. The depicted example of FIG. 1A is provided for the purpose of explanation only and is not meant to imply architectural limitations with respect to embodiments of the present invention.

FIG. 2 depicts a flowchart of a method 200 including steps 205-220 for generating a knowledge base of mathematical formulae in one or more technical documents, in accordance with an embodiment of the present invention. The method 200 may include one or more of the steps 205-220, in any combination, and is not limited to these steps only. In the present embodiment, the knowledge base is a graph database.

The knowledge management module (160) is executed by the processing unit (120) to cause the processing unit (120) to perform at least one or more steps of the 205-220, as described below.

At step 205, mathematical formulae is extracted from the one or more technical documents. A machine learning model is used to identify formulae regions in the PDF and convert them into machine readable format. The term ‘formulae regions’ refer to regions in the one or more technical documents that contain mathematical formulae. The formulae regions may correspond to ‘Inline formula’ or ‘Block Formulae’. Inline formulae refer to the mathematical formulae or variables that are part of natural language text lines in the one or more technical document. Block formulae refer to those mathematical formulae that are separately written in blocks, for example, between paragraphs of text. FIG. 3A illustrates identification of inline formulae and block formulae in a sample snippet 305 of a technical document, in accordance with an embodiment of the present invention.

In particular, by training based on training data, the machine learning model is able to adapt to new circumstances and to detect and extrapolate patterns. In general, parameters of the machine learning model may be adapted by means of training. In particular, supervised training, semi-supervised training, unsupervised training, reinforcement learning and or active learning may be used. Furthermore, feature learning may be used. In particular, the parameters of the machine learning model may be adapted iteratively by several steps of training. In particular, a machine learning model may comprise a neural network, a support vector machine, a decision tree and or or a Bayesian network, and or the machine learning model may be based on k-means clustering, Qlearning, genetic algorithms and or association rules.

In particular, a neural network may be a deep neural network, a convolutional neural network or a convolutional deep neural network or variations thereof. Furthermore, a neural network may be an adversarial network, a deep adversarial network and or a generative adversarial network. In an embodiment, a Masked Region—Convolutional Neural Network (abbreviated as MRCNN) based on deep neural network model is used to identify both block formulae and inline formulae. For example, the MRCNN based deep neural network model was trained on a set of annotated images of PDFs to identify both block formulae and inline formulae. Further, sentences comprising inline formulae are extracted and stored. Similarly, the block formulae are first converted into image format, are then converted to machine-readable format. In an embodiment, the block formulae in image format is converted into machine-readable format using a trained deep-learning model. For example, the block formulae are fed through a module that converts formulae images to their XHTML or Latex format. In one embodiment, an enhanced version of Harvard's IM2Latex model may be used as a starting point.

In another embodiment, open-source datasets may be used as technical documents with XHTML structure. The XHTML structure or format allows extracting variables, mathematical concepts and equation features from the documents as these concepts are enclosed with tags. The advantage of using XHTML documents is that the information is enclosed in tags. Using the XHTML document removes the rate of error by avoiding wrongly identified words as mathematical concepts. Once the mathematical concepts are extracted from the documents, the variables and the concepts may be identified that are related to each other.

At step 210, variables and the concept associated with each of the variables are identified from the one or more technical documents. In other words, the mentions of the concepts (types) and the symbols used to denote them (variables) are identified. To identify the concepts, present in the mathematical blocks extracted from the one or more technical documents, an extensive list of keywords as potential concepts is used. For example, to determine specifically the mathematical concepts, present in the mathematical blocks extracted from the XHTML documents, an extensive list of keywords as potential mathematical concepts is used. The extracted mathematical block is converted into a mathematical vector representation using flags.

FIG. 3B shows an example of a block 310 extracted from the one or more technical documents, in accordance with an embodiment of the present invention. The block comprises two concepts ‘segmentation image’ and ‘random variable’ associated with variables Γ and δ respectively. Each word in the block is represented by an aggregation of three components: word embedding of constituent tokens, type flags, and variable flags. Here, the variable flags indicate whether a token corresponds to a variable or not. For example, if the token corresponds to a variable, the token is assigned a variable flag of ‘1’, and ‘0’ otherwise. FIG. 3C shows assignment of variable flags to the block 310, in accordance with an embodiment of the present invention. Similarly, the type flag indicates whether the token corresponds to a concept or specific equation feature or not. If the token corresponds to a concept, the token is assigned a type flag of ‘1’, and ‘0’ otherwise. FIG. 3C shows assignment of type flags to the block 310, in accordance with an embodiment of the present invention. Once the representation of the mathematical formulae into variables and concepts is constructed, a classification model is used to classify where an edge between two words in the concept relates them together or not. In an embodiment, the classification model is a Convolutional Neural Network (CNN) classifier.

FIG. 4 illustrates structure of the CNN classifier (400), in accordance with an embodiment of the present invention. Similarly, all the variables and the associated concepts are identified from the one or more technical documents.

The CNN classifier classifies the contents laid out by LaTex and the operation is performed throughout different layers of CNN to identify edges of words, associating the mathematical symbols to determine how they are related to each other with intervention of variable typing module. The variable typing module also identifies the mention of mathematical concepts and symbols that are used to denote them. In other words it establishes which symbol implies which mathematical concept. As the contents from LaTex are accessed the step follows ‘convolution’, then improving nonlinearity and enhancing flexibility of obtained content. Thus the edge detection and association of variable with concepts is achieved.

In an exemplary situation, Mathematical Retrieval Collection (MREC) is used as a corpus for training word and type embeddings. For training the CNN classifier, the dataset using in “Variable Typing: Assigning Meaning to Variables in Mathematical Text” (Author: Yiannos Stathopoulos, Simon Baker, Marek Rei, Simone Teufel) is used. Details of the dataset are provided in table below. The best model based on performance on the validation set is selected. Additionally, a human evaluation of the model with 400 sentences extracted from the document collection is also conducted and an accuracy of 87.4% is achieved.

TABLE 1
The dataset used for training word and type embeddings

| | Train | Validation | Test | Total |
|---|---|---|---|---|
| Sentences | 5273 | 841 | 1689 | 7803 |
| Positive edges | 1995 | 457 | 1049 | 3501 |
| Negative edges | 15164 | 4386 | 10473 | 30023 |

Once variables and the associated concept or specific equation features are identified, a list of mathematical concepts and the terms or variables they are denoted with is obtained. At step 215, the interdependencies between variables in the extracted mathematical formulae are determined based on the identified variables and the concepts associated with the variables. The primary aim is to identify all variables occurring inside each mathematical equation and use the concepts obtained at step 210 to identify relations between the variables. In one embodiment, the inline formulae and the block formulae are compared to the variables, for example, using a string matching algorithm in order to identify the relations. FIG. 3E shows an example of a relation identified between a variable and a block formula in a block 340, in accordance with an embodiment of the present invention.

In an exemplary embodiment, to link the variables, the formulas are given as input to a simple string-matching module. This module takes the MathML format and links variable with equations. To improve linking accuracy, several heuristics were also used, for example: Superscript, subscript invariant string matching, i.e. x, xi, xj are considered variables of the same type; or Consider only the L.H.S. of formulae as variables. For example, in the inline formulae μ=2πα, only μ is considered a variable. After conducting a human evaluation on the linking output from 5 mathematically rich documents and an accuracy of 92% is achieved.

In the above steps 205-215, the knowledge management module160 obtains information related to the variables and the concepts associated with the variables, as and when they are occurring in the formulae in the technical documents by extracting terms present in the formulae; by identifying variables and the concepts, and how those concepts are associated with the variables. The knowledge management module160 further obtains information about how the multiple identified variables are inter-linked with each other. Subsequent to obtaining the above information from the technical documents, the knowledge management module (160) further builds a graph-based data model capturing this information in order to store them in a knowledge database.

To build the graph-based data model at step 220, the knowledge management module (160) may create multiple entities such as nodes, each one of them capturing information related to either a variable, or a concept, or a formulae, and the like. Further, the knowledge management module (160) may identify relations among those nodes and create relations among the nodes. The relations between the nodes may be represented by an interconnecting entity or interconnecting line between them. Further, the interconnections created between the nodes may capture information or attributes about the relations between the nodes, for example, how, what and why two particular nodes are connected. In an embodiment, the relationships may be uni-directional or bi-directional. In an embodiment, single entity can be connected to multiple entities via multiple relationships.

Thus, by creating multiple nodes and interconnections between those nodes, the knowledge management module (160) may capture information related to variables, concepts and formulae in a graph-based data model. Over a period of time, as and when the data model keeps on building up, the knowledge database keeps on storing these mathematical formulae and the variables and associated concepts.

The relations obtained after linking the variable and equations are translated into a graph containing edges and nodes. In an embodiment, since the relations types are exhaustive in nature, a list of relations that are possible between types of nodes are used. Based on the knowledge that from which part of the document and formulae the node comes, the relationship edges are drawn capturing the attributes, such as contains, of type, etc. Once many documents are processed, the knowledge graph is also to highlight the relationship between different concepts too. The graph can be stored on Graph Databases such as D-Graph, this allows the knowledge graph to be searched using graph queries.

At step 220, in an embodiment, three kinds of nodes are created and connected to show interrelations between the variables and the concepts and the formulaes that contain those variables and the concepts. The nodes are of three types-‘concept’ node, ‘variable’ node and ‘formula’ node. More specifically, each of the concepts identified is stored as a concept node. The variables corresponding to each of the concept nodes are added as variable node. Further, each of the variable nodes is connected to the respective concept node. Further, the mathematical formula associated with the concept and associated variable is added as a formula node. It must be understood that a given ‘formula’ node may be connected to multiple variable nodes and each variable node will be connected to one associated concept node. Typically, in a technical document, multiple mathematical formulae exist. Each such mathematical formula interrelates a given set of variables and associated concepts.

FIG. 5 is a Graphical User Interface view 500 of a knowledge base, in accordance with an embodiment of the present invention. These physical variables stored as nodes may also be associated with physical measurements or concepts. This visualization in the form of knowledge graph provides effective methods to retrieve relevant formulae, for e.g., for an engineering application at hand by machines. E.g., in case an engineer is interested to understand what all are the important formulae associated with a particular concept or if he is interested in a particular task and wants to know the relevant formulae, this knowledge base helps him to obtain such information from a corpus of documents. Search for mathematical formulae is now not limited to search by keywords or semantic search, while wholly excluding formulae.

More specifically, a snippet of a knowledge graph comprising a plurality of nodes 505, 510 . . . 550 for mathematical formulae related to a concept ‘Entropy’ is shown as an example. The concept is indicated by the central node 505. Further, various mathematical formulae related to the concept is indicated by the formula nodes 505, 510, 515, 520, 525 and 530. Similarly, the variables are represented by the variable nodes 535, 540, 545 and 550. ‘Entropy’ has been referred using different variables in different technical documents. The knowledge graph identifies the common concept irrespective of it being referred using different variables, thereby creating a wholistic connected graph. The various mathematical formulae involving entropy calculation in different contexts, using different surface forms is shown in the graph. Furthermore, the knowledge graph also shows the variables and their type or concept as well.

Thus, in the given example, the knowledge management module (160) may create an ‘Entropy’ node for capturing concept of ‘Entropy’. Further, the knowledge management module (160) may identify one or more variables connected or related to this concept ‘Entropy’. The information for these variables are captured in the variable nodes. Also, the knowledge management module (160) may interconnect the ‘Entropy’ node with multiple variable nodes via interconnections or interconnecting entities that represent how, what or why (or in combination) the variable nodes are related to the ‘Entropy’ node. Furthermore, the knowledge management module (160) may identify mathematical formulae related to the ‘Entropy’ node and the associated variables. The mathematical formulae are captured in the formulae node and connected to the ‘Entropy’ node through the one or more variables nodes via the interconnecting entities. Thus, a particular path in the graph-based data model connecting the ‘Entropy’ node, one or more variable nodes and the mathematical formulae may represent a particular mathematical formulae for ‘Entropy’ that captures the concept ‘Entropy’ and the one or more variables that are included in the particular formulae.

Such capturing of information related to the concepts, variables and formulae and their interconnections and interdependencies in the data model helps in creating a searchable knowledge database for the mathematical or scientific formulae.

In an embodiment, the system (105) includes a Graphical User Interface for visual representation of the graph-based data model.

Advantageously, embodiments of the present invention facilitate conversion of mathematical formulae in technical documents to machine-processable artifacts. As a result, the mathematical formulae becomes searchable as the contents of the mathematical formulae are now understood and associated with relevant concepts. Thus, mathematical formulae becomes a searchable artifact. An end-user may query the knowledge base, for example, based on the concept to retrieve all mathematical formulae it is associated with the concept. Embodiments of the present invention also enable the end-user to understand relationships between mathematical formulae in one or more technical documents.

Embodiments of the present invention may take the form of a computer program product (non-transitory computer readable storage medium having instructions, which when executed by a processor, perform actions) comprising program modules accessible from computer-usable or computer-readable medium storing program code for use by or in connection with one or more computers, processors, or instruction execution system. For the purpose of this description, a computer-usable or computer-readable medium is any apparatus that may contain, store, communicate, propagate, or transport the program for use by or in connection with the instruction execution system, apparatus, or device. The medium may be electronic, magnetic, optical, electromagnetic, infrared, or semiconductor system (or apparatus or device) or a propagation mediums in and of themselves as signal carriers are not included in the definition of physical computer-readable medium include a semiconductor or solid state memory, magnetic tape, a removable computer diskette, random access memory (RAM), a read only memory (ROM), a rigid magnetic disk and optical disk such as compact disk read-only memory (CD-ROM), compact disk read or write, and DVD. Both processors and program code for implementing each aspect of the technology may be centralized or distributed (or a combination thereof) as known to those skilled in the art.

Embodiments of the invention stated are not drawn to create or contrive a mathematical formulae per se rather aims to perform as an identifier of mathematical formulae or features and it's components as depicted in any technical document or matrix. It does not relate to any abstract theory or generic mathematical formulae. The sound objective is to disclose an efficient and optimum method to create a knowledge base to perform desires function of identifying mathematical expressions present in any technical document.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for building a knowledge database for mathematical formulae present in one or more technical documents, comprising: extracting, by a knowledge management module executable by one or more processing units, one or more mathematical formulae from the one or more technical documents; identifying, by a knowledge management module a mathematical concept and one or more variables associated with the mathematical concept from the extracted mathematical formulae; determining, by a knowledge management module, interdependencies between the identified one or more variables in the extracted mathematical formulae for linking the identified one or more variables, based on the identified one or more variables and the mathematical concepts associated with the one or more variables; and generating a knowledge graph based on the linking of variable and mathematical concept associated.

2. The method as claimed in claim 1, wherein the knowledge management module executable by one or more processing units perform the function of extracting the mathematical formulae, identifying variables associated with the mathematical and determining interdependencies between the identified one or more variables so as to create one or more entities that are interconnected to each other in a graph-based data model, wherein the one or more entities include at least one or more of: an concept entity to capture information related to the identified mathematical concept; a variable entity to capture information related to each of the identified one or more variables associated with the mathematical concept; a formula entity to capture information related to each of the extracted mathematical formulae; a first relationship entity to capture information related to interconnection between the identified mathematical concept and the identified one or more variables associated with the mathematical concept, and a second relationship entity to identify interconnection between the formula entity with on or more variable entities with respect to certain mathematical formula wherein, by creating the graph-based data model including the one or more entities representing the mathematical formulae, the knowledge management module converts the mathematical formulae into searchable objects and stores the searchable mathematical formulae in the knowledge base included in the system.

3. The method as claimed in claim 2, wherein for extracting the one or more mathematical formulae from the one or more technical documents, the knowledge management module is executable by the one or more processing units to implement a machine learning model that uses a neural network to identify one or more formulae regions in the one or more technical documents, wherein the formulae regions are regions in the one or more technical documents that contain the mathematical formulae, and wherein the formulae region includes at least one of an inline formula and a block formulae, and wherein the inline formulae refer to the mathematical formulae or the one or more variables that are part of natural language text lines in the one or more technical documents, and the block formulae refer to the mathematical formulae that are separately written in blocks including between paragraphs of text; convert the formulae regions into machine readable format; and wherein the machine learning model trains the neural network on a set of annotated images of the technical documents to identify both block formulae and inline formulae.

4. The method as claimed in claim 3, wherein for the identifying of the mathematical concept and one or more variables associated with the mathematical concept, the knowledge management module is executable by the one or more processing units in the method to:
convert the machine-readable format of the formulae regions into a mathematical vector representation using flags, wherein each word in the formulae regions is represented in the mathematical vector representation by an aggregation of three components including: a type flag for flagging a mathematical concept to each word in the formulae regions; a variable flag for flagging a variable to each word in the formulae regions; and a word embedding of constituent words in the formulae regions, and wherein a classification model is further implemented by the knowledge management module to classify an edge between words in the mathematical concept indicating the edge relates the two words together or not.

5. The method as claimed in claim 3, wherein for determining the interdependencies between the identified one or more variables in the extracted mathematical formulae, the knowledge management module is executable by the one or more processing units in the method to: identify all of the variables occurring inside each of the formulae regions which is in the machine readable format; use the identified mathematical concepts to identify relations between the variables; input the identified variables and the mathematical concepts to a string-matching module that links the identified variables with the identified mathematical concepts and in turn with the extracted mathematical formulae.

6. The method as claimed in claim 1, further comprising: communicate with a client device communicating via a network for the client device to search through the knowledge database and to obtain one or more mathematical formulae, related to a mathematical concept, stored in the knowledge database; provide the graph-based data model to the client device for obtaining one or more mathematical formulae related to a mathematical concept, stored in the knowledge database; visually represent the graph-based data model at a Graphical User Interface of a system or the client device; and wherein the knowledge management module receives the technical documents at least from at least one of the client device communicating with the knowledge management module via the network, a web source, a node residing on the network, or an system in the network, individually or in any combination.

7. The method as claimed in claim 6, wherein for the identifying of a mathematical concept and one or more variables associated with the mathematical concept, the knowledge management module is configured to perform: conversion of the machine-readable format of the inline formulae regions into a mathematical vector representation using flags, wherein each word in the formulae regions is represented in the mathematical vector representation by an aggregation of three components including: a type flag for flagging a mathematical concept to each word in the formulae regions; a variable flag for flagging a variable to each word in the formulae regions; wherein a word embedding of constituent words in the formulae regions, and a classification model is implemented by the knowledge management module to classify an edge between two words with variable tags to identify the variables related to the mathematical concept.

8. The method as claimed in claim 7, wherein to identify the mathematical concept, present in the formulae regions, an extensive list of keywords as potential concept is used by the knowledge management module, and wherein the classification model is a Convolutional Neural Network classifier.

9. The method as claimed in claim 1, wherein the knowledge management module is further configured to apply one or more heuristics approaches to improve accuracy, where the one or more heuristics approaches at least includes at least Superscript, subscript invariant string matching, where variables i.e. x, xi, xj are considered variables of the same type; or consider only the L.H.S. of the mathematical formulae as variables.

10. A system for building a knowledge base for mathematical formulae present in one or more technical documents, comprising: one or more processing units: a memory coupled to the one or more processing unit for execution of one or more machine-readable instructions; and a knowledge management module stored in the memory, and wherein, upon execution of the one or more machine-readable instructions, by the processing unit, causes the knowledge management module to perform the method steps of claim 1.
